(19) United States
(12) Patent Application Publication
(10) Pub. No.: US 2023/0166794 A1
(43) Pub. Date: Jun. 1, 2023

(54) Vehicle and Method of Controlling the Same

(71) Applicants: Hyundai Motor Company, Seoul (KR); Kia Corporation, Seoul (KR)

(72) Inventor: Jaekyun Kim, Seongnam-si (KR)

(21) Appl. No.: 18/053,860

(22) Filed: Nov. 9, 2022

(30) Foreign Application Priority Data
Nov. 29, 2021 (KR) 10-2021-0167565

(51) Int. Cl. B62D 17/00; B62D 15/02; G06T 7/00; G06T 7/50; G06T 7/60

(52) U.S. Cl. CPC B62D 17/00; B62D 15/025; G06T 7/0002; G06T 7/50; G06T 7/60; G06T 2207/30256

(57) ABSTRACT

An embodiment vehicle includes a camera having an external field of view with respect to the vehicle and a controller configured to process image data obtained by the camera to determine a wheel alignment state of the vehicle and detect an abnormality in wheel alignment of the vehicle by comparing an initial wheel alignment state of the vehicle with a driving wheel alignment state obtained while the vehicle is being driven.

### CROSS-REFERENCE TO RELATED APPLICATIONS

This application claims the benefit of Korean Patent Application No. 10-2021-0167565, filed on Nov. 29, 2021, which application is hereby incorporated herein by reference.

### TECHNICAL FIELD

The present disclosure relates to a vehicle and a method of controlling the same.

### BACKGROUND

In general, wheel alignment of a vehicle further increases flexibility of the vehicle and the contact with a road surface by maintaining a balance of forces against friction, acceleration, centrifugal force, and driving force according to a movement of the vehicle, thereby improving steering performance of the vehicle and maintaining a more stable vehicle posture in straight or turning positions.

Wheel alignment involves various elements such as a toe, a camber, a caster, and a kingpin inclination angle, which complement each other to reduce handling force of a steering wheel, provide safety of steering wheel operation, and provide straightness of a vehicle, restoration of a steering wheel, and reduction of tire wear.

Meanwhile, wheel alignment needs to be maintained according to an initial design, but may be distorted by an external physical impact. If the wheel alignment deviates from the initial design, straightness of a vehicle may be reduced and uneven wear of the tire may occur.

When a vehicle performs autonomous driving while deviating from an initial design of wheel alignment, the vehicle has difficulty travelling on an intended trajectory thereof, so that performance such as lane following may significantly deteriorate.

In particular, in autonomous vehicles, a technology that detects an abnormality in a vehicle and performs correction and alarm by itself is required, and at this time, a subject of detecting the abnormality should give priority to a vehicle rather than a driver.

### SUMMARY

The present disclosure relates to a vehicle and a method of controlling the same. Particular embodiments relate to a vehicle for detecting an abnormality in wheel alignment and automatically correcting the abnormality in wheel alignment, and a method of controlling the same.

An embodiment of the disclosure provides a vehicle capable of detecting a wheel alignment deviation in an autonomous driving vehicle by itself and performing accurate autonomous driving if wheel alignment is misaligned, and a method of controlling the same.

Additional embodiments of the disclosure will be set forth in part in the description which follows and, in part, will be obvious from the description, or may be learned by practice of the disclosure.

In accordance with an embodiment of the disclosure, a vehicle includes a camera installed to have an external field of view with respect to the vehicle and configured to obtain image data and a controller configured to process the image data to determine a wheel alignment state of the vehicle, wherein the controller is configured to detect an abnormality in wheel alignment by comparing an initial wheel alignment state of the vehicle with a wheel alignment state obtained while driving the vehicle.

The controller may be further configured to change an offset of a steering device in response to the abnormality in wheel alignment being detected.

The vehicle may further include a communicator configured to receive map data from outside, wherein the controller is further configured to process the map data to determine whether a road on which the vehicle is traveling corresponds to a test road and activate a monitoring mode for determining the wheel alignment state in response to the road being the test road.

The controller may be further configured to, when the test road is a straight road, control the steering device to keep a steering wheel of the vehicle in a straight forward state and detect the abnormality in wheel alignment based on a change in a distance between the vehicle and a lane of the straight road.

The controller may be further configured to process the image data to calculate a lane curvature of a front lane, calculate a motion curvature of the vehicle by the steering device, and detect the abnormality in wheel alignment based on a difference between the lane curvature and the motion curvature.

The vehicle may further include a communicator configured to receive a target curvature of a surrounding vehicle from the surrounding vehicle driving in the vicinity of the vehicle, wherein the controller is further configured to calculate a motion curvature of the vehicle by the steering device and detect the abnormality in wheel alignment based on a difference between the target curvature of the surrounding vehicle and the motion curvature.

The controller may be further configured to change the offset of the steering device for any one of front wheels or rear wheels of the vehicle.

The controller may be configured to change the offset of the steering device with respect to front wheels and rear wheels of the vehicle.

The controller may be configured to determine the offset based on a pre-stored lookup table.

The controller may be configured to output an abnormality detection signal in response to the abnormality in wheel alignment being detected.

In accordance with another embodiment of the disclosure, a method for controlling a vehicle includes obtaining, by a camera, image data, determining, by a controller, a wheel alignment state of the vehicle by processing the image data, and detecting, by the controller, an abnormality in wheel alignment by comparing an initial wheel alignment state of the vehicle with a wheel alignment state obtained while driving the vehicle.

The method may further include changing, by the controller, an offset of a steering device in response to the abnormality in wheel alignment being detected.

The method may further include receiving, by a communicator, map data from outside, determining, by the controller, whether a road on which the vehicle is traveling corresponds to a test road by processing the map data, and activating, by the controller, a monitoring mode for determining the wheel alignment state in response to the road being the test road.

Detecting the abnormality in wheel alignment may further include, when the test road is a straight road, controlling the steering device to keep a steering wheel of the vehicle in a straight forward state and detecting the abnormality in wheel alignment based on a change in a distance between the vehicle and a lane of the straight road.

Detecting the abnormality in wheel alignment may further include calculating, by the controller, a lane curvature of a front lane by processing the image data, calculating, by the controller, a motion curvature of the vehicle by the steering device, and detecting, by the controller, the abnormality in wheel alignment based on a difference between the lane curvature and the motion curvature.

The method may further include receiving, by a communicator, a target curvature of a surrounding vehicle from the surrounding vehicle driving in the vicinity of the vehicle, wherein detecting the abnormality in wheel alignment further includes calculating, by the controller, a motion curvature of the vehicle by the steering device and detecting the abnormality in wheel alignment based on a difference between the target curvature of the surrounding vehicle and the motion curvature.

Detecting the abnormality in wheel alignment may further include changing, by the controller, the offset of the steering device for any one of front wheels or rear wheels of the vehicle.

Detecting the abnormality in wheel alignment may further include changing, by the controller, the offset of the steering device with respect to front wheels and rear wheels of the vehicle.

Changing the offset may further include determining, by the controller, the offset based on a pre-stored lookup table.

The method may further include outputting, by the controller, an abnormality detection signal in response to the abnormality in wheel alignment being detected.

### BRIEF DESCRIPTION OF THE DRAWINGS

These and/or other aspects of embodiments of the disclosure will become apparent and more readily appreciated from the following description of the exemplary embodiments, taken in conjunction with the accompanying drawings, in which:

FIG. 1 shows a configuration of a vehicle according to an embodiment of the disclosure;

FIG. 2 shows a control block diagram of a vehicle according to an embodiment of the disclosure;

FIG. 3 is a flowchart illustrating a method of controlling a vehicle according to an embodiment of the disclosure;

FIGS. 4 and 5 are views for explaining a process of calculating a motion curvature of a vehicle according to an embodiment of the disclosure;

FIG. 6 is a view for explaining a process of calculating a lane curvature.

FIG. 7 is a flowchart illustrating a method of controlling a vehicle according to an embodiment of the disclosure; and

FIG. 8 is a flowchart illustrating a method of controlling a vehicle according to another embodiment of the disclosure.

### DETAILED DESCRIPTION OF ILLUSTRATIVE EMBODIMENTS

Reference will now be made in detail to the embodiments of the disclosure, examples of which are illustrated in the accompanying drawings, wherein like reference numerals refer to like elements throughout. This specification does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘parts’, ‘modules’, ‘members’, ‘blocks’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and “indirectly connected to” includes being connected to the other element via a wireless communication network.

Also, it is to be understood that the terms “include” and “have” are intended to indicate the existence of elements disclosed in the specification and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, embodiments of the disclosure will be described in detail with reference to the accompanying drawings.

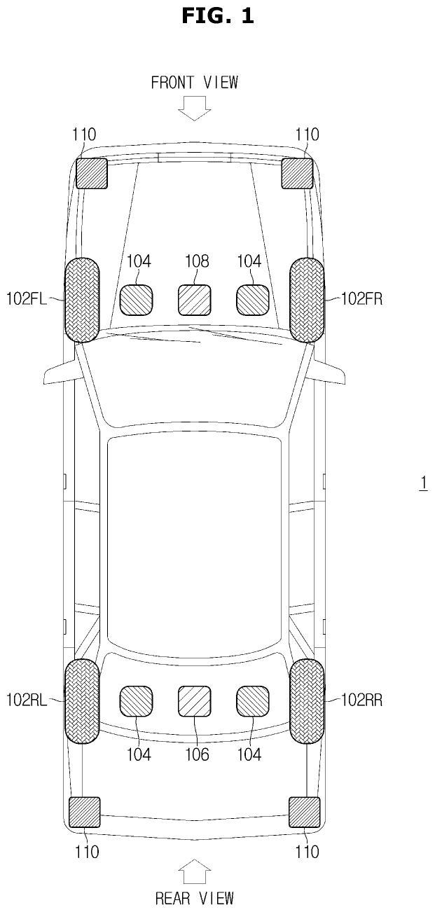

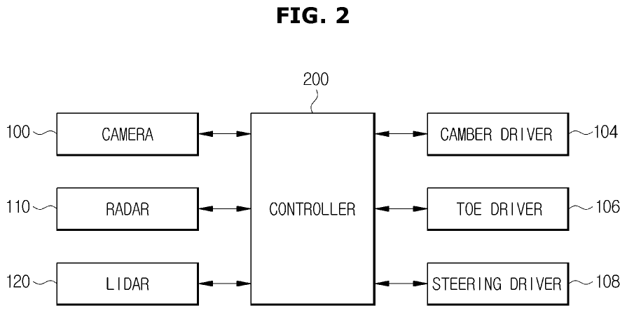

FIG. 1 is a view illustrating a configuration of a vehicle according to an exemplary embodiment of the disclosure, and FIG. 2 is a view illustrating a control block diagram of a vehicle according to an exemplary embodiment of the disclosure.

A vehicle 1 according to an embodiment of the disclosure includes a wheel 102, a camber driver 104, a toe driver 106, a steering driver 108, and a radar 110.

The wheel 102 includes two front wheels (e.g., a front left (FL) wheel and a front right (FR) wheel) 102FL and 102FR, and two rear wheels (e.g., a rear left (RL) wheel and a rear right (RR) wheel) 102RL and 102RR. In the following description, FL, FR, RL, and RR are added to reference numeral 102 to designate a specific wheel, and when referring to all four wheels, only reference numeral 102 is used.

The camber driver 104 is provided for each of the four wheels 102. A camber angle of each wheel 102 may be independently controlled by motion of four independent camber drivers 104.

The toe driver 106 is also referred to as rear wheel steering (RWS). The toe driver 106 is a device for controlling toe angles of the rear wheels 102RL and 102RR. By controlling the toe angles of the rear wheels 102RL and 102RR according to a driving state of the vehicle 1 (e.g., a speed, etc.), a driving stability of the vehicle 1 is improved.

The steering driver 108 is a steering device adapting motor driven power steering (MDPS). In other words, the steering driver 108 changes a driving direction of the vehicle 1 by controlling a rotation axis direction of the front wheels 102FL and 102FR in response to a user's manipulation of a steering wheel. The steering driver 108 controls the rotation axis direction of the front wheels 102FL and 102FR by using a driving force of the motor.

On the other hand, the vehicle 1 according to embodiments of the disclosure in order to perform an autonomous driving function may perform at least any one or more functions such as smart cruise control (SCC), forward collision warning (FCW), lane keeping assist (LKA), lane departure warning (LDW), lane change alert (LCA), highway driving assist (HDA), or lane following assist (LFA), or the like.

To perform the autonomous driving function, the vehicle 1 includes a camera 100 that obtains image data around the vehicle 1, a radar 110 that obtains object data around the vehicle 1, and a light detection and ranging (lidar) that obtains lidar data, which is data in the form of a point of an object.

The camera 100 may include an electronic control unit (ECU) (also referred to as a controller), and photograph the front of the vehicle 1 to recognize other vehicles, pedestrians, cyclists, lanes, road signs, and the like.

The radar 110 may include an ECU (not shown), and obtain a relative position, a relative speed, etc. of an object (e.g., any other vehicle, a pedestrian, a cyclist, etc.) around the vehicle 1.

The lidar 120 may include an ECU (not shown), and generate lidar data from a laser pulse reflected after emitting the laser pulse toward the front of the vehicle 1 on a road, and detect objects (e.g., other vehicles, lanes, pedestrians, cyclists, etc.) existing around the vehicle with precise resolution.

On the other hand, although not shown in FIG. 2, the vehicle 1 may include a communicator (not shown) that supports a Vehicle to X (V2X) communication. Herein, X in V2X refers to everything, for example, infra/vehicle/nomadic, etc., and refers to all types of communication manners applicable to vehicles, and is a general term and refers to a specific communication technology to implement a connected vehicle or a networked vehicle. The V2X communication may be divided into three categories, vehicle to infrastructure (V2I), vehicle to vehicle (V2V), and vehicle to nomadic devices (V2N), and it is expected that other types of communication categories will be added recently. In this case, the communicator may be provided with a communication interface supporting V2V communication and a communication interface supporting V2I communication, respectively, or may be integrated into one unit.

A controller 200 includes a memory (not shown) for storing and/or recording programs for controlling operation of the vehicle 1, instructions and data, and a processor (not shown) for generating a control signal for controlling the operation of the vehicle 1 based on the programs, instructions and data that are stored and/or recorded in the memory. The controller 200 may be implemented as a control circuit in which a processor and a memory are embedded. Furthermore, the controller 200 may include a plurality of processors and a plurality of memories.

The memory may store/record various types of information necessary for the operation of the vehicle 1. For example, the memory may store a lookup table in which a steering angle δ, a heading angle Ψ, and a slip angle β of the vehicle 1 are calculated according to a specific conditional expression and reflected in a 3×3 matrix. Furthermore, the memory may store an offset value corresponding to a value allocated to the stored lookup table.

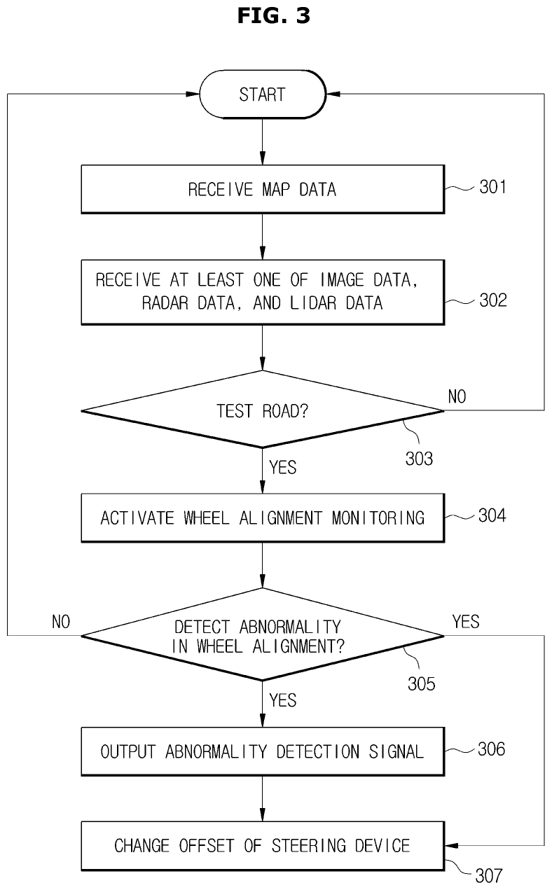

FIG. 3 is a flowchart illustrating a method for controlling a vehicle according to an exemplary embodiment of the disclosure.

The vehicle 1 receives map data (301). The map data is a digital map acquired through V2X communication from the outside thereof or stored in advance, and is data including terrain information on a current location.

The vehicle 1 receives at least one of image data, radar data, and lidar data (302).

The vehicle 1 processes the image data or the lidar data to determine whether the road currently being driven corresponds to a test road (303). Herein, the test road is a road without curves or obstacles on a surface thereof, and corresponds to a road in which absolute straightness may be guaranteed in an initial state or in a wheel alignment state immediately after regular inspection.

In response to the road currently being driven being the test road, the vehicle 1 activates a wheel alignment monitoring (304).

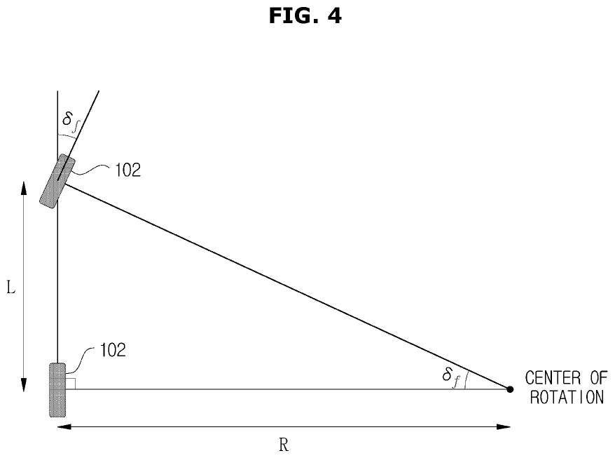

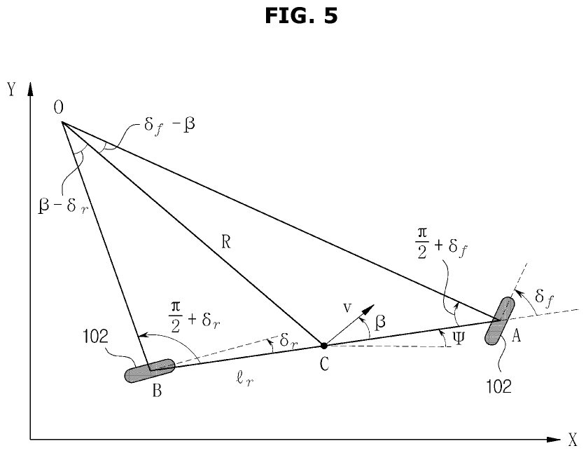

The vehicle 1 detects an abnormality in wheel alignment caused by miscellaneous factors such as external impact (305). A detailed process for detecting the abnormality in wheel alignment will be described in detail with reference to FIGS. 4 and 5.

When the abnormality in wheel alignment is detected, the vehicle 1 outputs an abnormality detection signal (306). More specifically, the controller 200 may notify a user of the abnormality in wheel alignment by providing the abnormality detection signal to an output device such as a display (not shown) or a speaker (not shown) provided in the vehicle 1.

Meanwhile, the vehicle 1 may change an offset of the steering device together with or separately from the abnormality detection signal output (307). For example, when a wheel alignment abnormality occurs, the autonomously driving vehicle 1 is pulled to either side instead of going straight as the camber or toe angle is changed even if a steering axis of the front wheel is in a straight state. Furthermore, even if the steering axis of the rear wheels is in the straight state, the autonomous vehicle 1 is pulled to either side rather than straight driving as the toe angle is changed.

If not in the autonomous driving mode, the phenomenon of the vehicle being pulled to either side due to a driver's unconscious manipulation may be alleviated, but at least a temporary driving error may occur in an autonomous driving mode.

Accordingly, in an embodiment of the disclosure, the abnormality in wheel alignment may be automatically detected, an initial wheel alignment state of the vehicle 1 and the wheel alignment state obtained while the vehicle 1 is driving may be compared, and an offset of the steering device in order to change a steering reference for the changed wheel alignment may be changed.

The controller 200 may change the offset of the steering device for any one of the front wheels of the vehicle 1 or the rear wheels of the vehicle 1, and change the offset of the steering device with respect to the front wheels of the vehicle 1 and the rear wheels of the vehicle 1. In the latter case, it may be applied to the vehicle 1 on which the RWS is mounted.

At this time, the vehicle 1 calculates an error amount of wheel alignment so as to determine a degree of offset. A detailed process related thereto will be described in detail with reference to FIGS. 4 and 5.

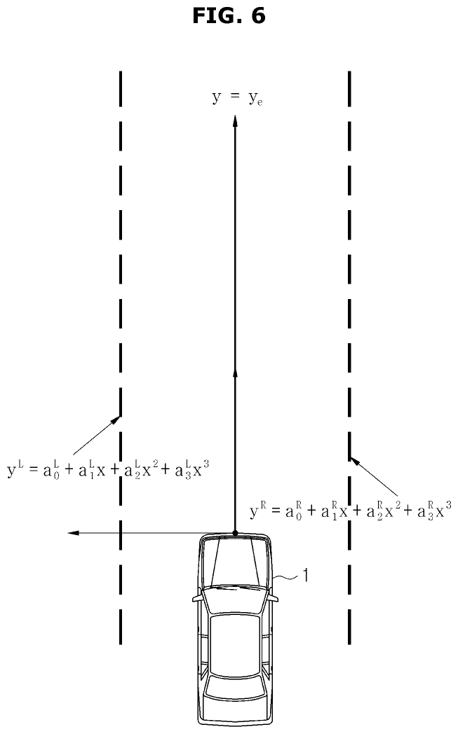

FIGS. 4 and 5 are views for explaining a process of calculating a motion curvature of a vehicle according to an embodiment of the disclosure, and FIG. 6 is a view for explaining a process of calculating a lane curvature.

FIGS. 4 and 5 are exemplary views assumed as a bicycle model, and the motion curvature of the vehicle 1 may be calculated based on the steering angle δ, the heading angle Ψ, and the slip angle β of the vehicle 1. The steering angle δ_{f} may be calculated by Equation 1, which is a relationship between a distance L between a center of the front wheel and a center of the rear wheel and a distance R between a center of rotation and a center of the rear wheel, and the motion curvature K is the inverse of R.

$$tan ( {δ}_{f} ) = \frac{L}{R} \qquad Equation 1$$

Furthermore, the heading angle Ψ and the slip angle β may be calculated by Equation 2 below (ψ the change amount of the heading angle).

$$tan ( δ ) = \frac{L}{R} \to K = \frac{tan ( δ )}{L} \dot{ψ} = \frac{V}{R} \to K = \frac{1}{R} = \frac{\dot{ψ}}{V} \qquad Equation 2$$

Meanwhile, referring to FIG. 6, when both the front wheels A and the rear wheels B are steered, a curvature K_{f} of the front wheel A and a curvature Kᵣ of the rear wheel B based on the steering angle δ_{f} of the front wheel and the wheel steering angle δᵣ of the rear wheel may be calculated by Equation 3 below, and the total motion curvature K may be calculated by Equation 4 below.

$$\frac{tan ( {δ}_{f} )}{L} = \frac{1}{R} = {K}_{f} , \frac{tan ( {δ}_{r} )}{L} = \frac{1}{R} = {K}_{r} \qquad Equation 3$$

$$K = {K}_{f} - {K}_{r} \qquad Equation 4$$

Furthermore, the slip angle β is calculated by Equation 5 below.

$$β = {tan}^{- 1} ( \frac{{l}_{f} tan ( {δ}_{r} ) + {l}_{r} tan ( {δ}_{f} )}{{l}_{f} + {l}_{r}} ) \qquad Equation 5$$

The motion curvature K is calculated based on the above-mentioned equations, resulting in obtaining the steering angle (δ), the heading angle (Ψ), and the slip angle (β), and a state of wheel alignment is determined through the data of the steering angle (δ), the heading angle (Ψ), and the slip angle (β).

On the other hand, referring to FIG. 6, a lane on the road on which the vehicle 1 is traveling may be expressed by Equation 6 below.

yₙ(xₙ)=a₀+a₁xₙ+a₂xₙ²+a₃xₙ³ Equation 6

(xn is the longitudinal position of the lane, yn is the lateral position of the lane, a0 is the lateral offset, a1 is the lane direction angle, a2 is the curvature, and a3 is the curvature derivative.)

The vehicle 1 may process the image data and/or lidar data to detect the position of the lane and calculate the lane curvature through the relational expression of Equation 6 described above.

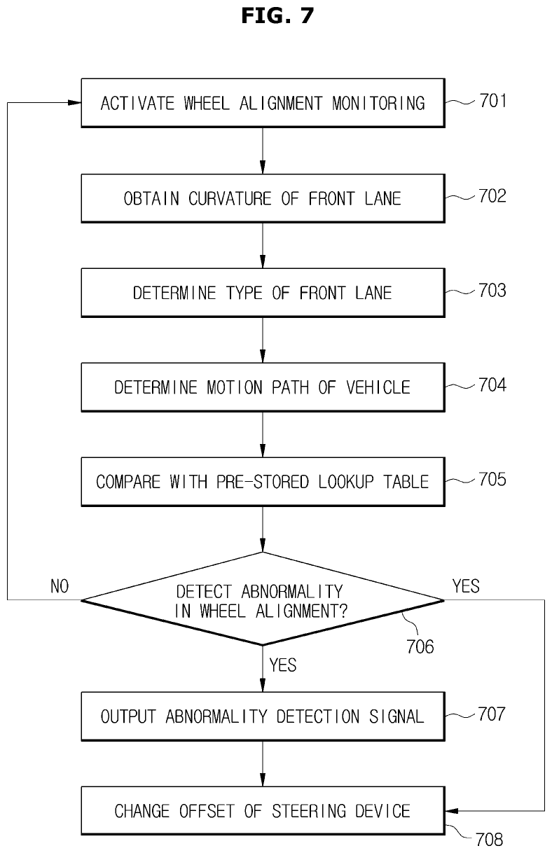

FIG. 7 is a flowchart illustrating a method for controlling a vehicle according to an embodiment of the disclosure.

Unlike the embodiment according to FIG. 3, the embodiment of FIG. 7 is to improve straight forward stability and steering accuracy of the vehicle 1 by correcting the offset of the steering device based on the curvature of a front lane in a situation other than the test road.

First, the vehicle 1 activates the wheel alignment monitoring (701). Here, an activation condition of the monitoring may be a user input or lane detection.

In response to the wheel alignment monitoring being activated, the vehicle 1 obtains the curvature of the front lane (702). More specifically, the controller 200 calculates the curvature of the front lane by processing the image data or the lidar data. Then, the controller 200 determines a type of the front lane (703). The type of the front lane include a straight lane, a left turn lane, and a right turn lane. The controller 200 may detect the abnormality in wheel alignment in comparison with a motion path of the vehicle 1 according to the determined type.

The vehicle 1 determines the motion path (704). In this case, the motion path includes the motion curvature when the vehicle 1 travels in the front lane, and the motion curvature of the vehicle 1 refers to the description of FIGS. 4 and 5.

Meanwhile, the controller 200 calculates the curvature of the front lane and the motion curvature of the vehicle 1 and compares these curvatures with the pre-stored lookup table (705), thereby detecting the abnormality in wheel alignment. For example, the memory (not shown) may store the lookup table in which the steering angle δ, the heading angle Ψ, and the slip angle β of the vehicle 1 are reflected in a 3×3 matrix according to a specific conditional expression. In this case, the controller 200 may determine the offset based on the pre-stored lookup table.

In response to the abnormality in wheel alignment being detected (YES at 706), the vehicle 1 outputs the abnormality detection signal (707). More specifically, the controller 200 may notify the user of the abnormality in wheel alignment by providing the abnormality detection signal to the output device such as a display (not shown) or a speaker (not shown) provided in the vehicle 1.

Meanwhile, the vehicle 1 may change the offset of the steering device together with or separately from the abnormality detection signal output (708).

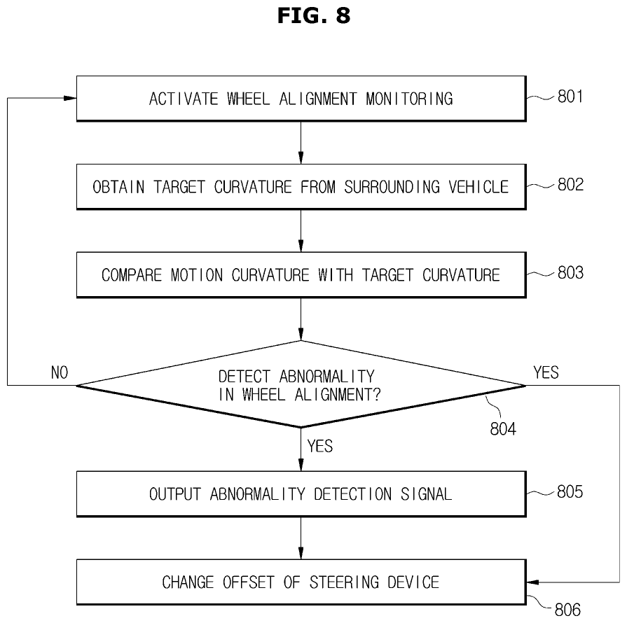

FIG. 8 is a flowchart illustrating a method of controlling a vehicle according to another embodiment of the disclosure.

An embodiment of the disclosure compares the curvature of a surrounding vehicle driving in the vicinity of the vehicle 1 with the motion curvature of the vehicle 1 to detect the abnormality in wheel alignment and corrects the offset of the steering device, thereby providing straight forward stability of the vehicle 1 and improving steering accuracy.

First, the vehicle 1 activates the wheel alignment monitoring (801). Herein, an activation condition of the monitoring may be a user input or detection of the surrounding vehicle.

The vehicle 1 obtains a target curvature from a surrounding vehicle (802). The target curvature is the curvature of the motion path of the surrounding vehicle, and is data provided from the surrounding vehicle by V2V manner among V2X communication.

The vehicle 1 performs a comparison between the motion curvature and the target curvature (803). This is based on the premise that when traveling on the same road, the vehicle should be driven by the same curvature. At this time, when the difference between the motion curvature and the target curvature is greater than or equal to a predetermined threshold, it may be determined that the abnormality in wheel alignment exists.

In response to the abnormality in wheel alignment being detected (YES at 804), the vehicle 1 outputs the abnormality detection signal (805). More specifically, the controller 200 may notify the user of the abnormality in wheel alignment by providing the abnormality detection signal to the output device such as a display (not shown) or a speaker (not shown) provided in the vehicle 1.

Meanwhile, the vehicle 1 may change the offset of the steering device together with or separately from the abnormal detection signal output (806).

As is apparent from the above, embodiments of the disclosure may provide a vehicle capable of improving the straight forward stability and steering accuracy of the autonomous vehicle by automatically changing the offset of the wheel alignment, and a method of controlling the same. In addition, the vehicle according to embodiments of the present disclosure may prevent uneven wear of the vehicle without separate maintenance.

Further, embodiments of the disclosure may provide a vehicle capable of self-diagnosing the wheel alignment state even if there is not a driver who may detect misaligning of wheel alignment in the autonomous vehicle, thereby improving straightness and driving stability.

On the other hand, the above-described embodiments may be implemented in the form of a recording medium storing commands executable by a computer. The commands may be stored in the form of program code. When the commands are executed by a processor, a program module is generated by the commands so that the operations of the disclosed embodiments may be carried out. The recording medium may be implemented as a computer-readable recording medium.

The computer-readable recording medium includes all types of recording media storing data readable by a computer system. Examples of the computer-readable recording medium include a read only memory (ROM), a random access memory (RAM), a magnetic tape, a magnetic disk, a flash memory, an optical data storage device, or the like.

Although embodiments of the disclosure have been shown and described, it would be appreciated by those having ordinary skill in the art that changes may be made in these embodiments without departing from the principles and spirit of the disclosure, the scope of which is defined in the claims and their equivalents.

What is claimed is:

1. A vehicle comprising:
a camera having an external field of view with respect to the vehicle; and
a controller configured to:
process image data obtained by the camera to determine a wheel alignment state of the vehicle; and
detect an abnormality in wheel alignment of the vehicle by comparing an initial wheel alignment state of the vehicle with a driving wheel alignment state obtained while the vehicle is being driven.

2. The vehicle of claim 1, wherein the controller is further configured to change an offset of a steering device in response to detection of the abnormality in wheel alignment.

3. The vehicle of claim 2, wherein the controller is further configured to change the offset of the steering device for front wheels or rear wheels of the vehicle.

4. The vehicle of claim 2, wherein the controller is further configured to change the offset of the steering device with respect to front wheels and rear wheels of the vehicle.

5. The vehicle of claim 4, wherein the controller is configured to determine the offset based on a pre-stored lookup table.

6. The vehicle of claim 1, further comprising a communicator configured to receive map data from an external source, wherein the controller is further configured to process the map data to determine whether a road on which the vehicle travels corresponds to a test road and activate a monitoring mode for determining the driving wheel alignment state based on the road being the test road.

7. The vehicle of claim 6, wherein, in response to the test road being a straight road, the controller is further configured to control a steering device to keep a steering wheel of the vehicle in a straight forward state and detect the abnormality in wheel alignment based on a change in a distance between the vehicle and a lane of the straight road.

8. The vehicle of claim 1, wherein the controller is further configured to process the image data to calculate a lane curvature of a front lane, calculate a motion curvature of the vehicle by a steering device, and detect the abnormality in wheel alignment based on a difference between the lane curvature and the motion curvature.

9. The vehicle of claim 1, further comprising a communicator configured to receive a target curvature of a surrounding vehicle from the surrounding vehicle driving in a vicinity of the vehicle, wherein the controller is further configured to calculate a motion curvature of the vehicle by a steering device and detect the abnormality in wheel alignment based on a difference between the target curvature of the surrounding vehicle and the motion curvature of the vehicle.

10. The vehicle of claim 1, wherein the controller is configured to output an abnormality detection signal in response to detection of the abnormality in wheel alignment.

11. A method for controlling a vehicle, the method comprising:
obtaining image data;
determining a wheel alignment state of the vehicle by processing the image data; and
determining whether there is an abnormality in wheel alignment by comparing an initial wheel alignment state of the vehicle with a driving wheel alignment state obtained while the vehicle is being driven.

12. The method of claim 11, further comprising changing an offset of a steering device in response to determining there is the abnormality in wheel alignment.

13. The method of claim 12, wherein detecting the abnormality in wheel alignment further comprises changing the offset of the steering device for front wheels or rear wheels of the vehicle.

14. The method of claim 12, wherein detecting the abnormality in wheel alignment further comprises changing the offset of the steering device with respect to front wheels and rear wheels of the vehicle.

15. The method of claim 14, wherein changing the offset further comprises determining the offset based on a pre-stored lookup table.

16. The method of claim 11, further comprising:
receiving map data from an external source;
determining whether a road on which the vehicle is traveling corresponds to a test road by processing the map data; and
activating a monitoring mode for determining the driving wheel alignment state in response to determining that the road is the test road.

17. The method of claim 16, wherein, when the test road is a straight road, detecting the abnormality in wheel alignment further comprises:
controlling a steering device to keep a steering wheel of the vehicle in a straight forward state; and
detecting the abnormality in wheel alignment based on a change in a distance between the vehicle and a lane of the straight road.

18. The method of claim 11, wherein detecting the abnormality in wheel alignment further comprises:
calculating a lane curvature of a front lane by processing the image data;
calculating a motion curvature of the vehicle by a steering device; and
detecting the abnormality in wheel alignment based on a difference between the lane curvature and the motion curvature.

19. The method of claim 11, further comprising:
receiving a target curvature of a surrounding vehicle from the surrounding vehicle driving in a vicinity of the vehicle;
calculating a motion curvature of the vehicle by a steering device; and
detecting the abnormality in wheel alignment based on a difference between the target curvature of the surrounding vehicle and the motion curvature of the vehicle.

20. The method of claim 11, further comprising outputting an abnormality detection signal in response to the abnormality in wheel alignment being detected.
